(19) United States
(12) Patent Application Publication
(10) Pub. No.: US 2006/0200657 A1
(43) Pub. Date: Sep. 7, 2006

(54) Network system, resources using device, and resources holding device

(75) Inventor: Masahiro Matsuda, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/365,666

(22) Filed: Mar. 2, 2006

(30) Foreign Application Priority Data
Mar. 2, 2005 (JP) 2005-058104

(51) Int. Cl. G06F 9/24; G06F 15/177; G06F 9/445

(52) U.S. Cl. 713/2

(57) ABSTRACT

In a network system, a resources using device which uses the resources in the resources holding device sends to the resources holding device a command to confirm whether the resources in the resources holding device are available. When receiving from the resources holding device a response showing that the resources are unavailable, the resources using device sends to the resources holding device a notification request command to request to send to the resources using device a derestriction notification showing that the resources have become to be available. After receiving the notification request command from the resources using device, the resources holding device sends to the resources using device the derestriction notification as soon as the unavailable resources have become to be available. Thus, the resources using device can either notify a user that the digital contents have become to be available or automatically start using the digital contents.

### BACKGROUND OF THE INVENTION

1. Field of the Invention

The present invention relates to a network system including a network device which holds resources such as digital contents, and a network device which uses the resources.

2. Description of the Related Art

There is known a network system including a network device which holds resources such as digital contents, a recording medium, the device itself, or the like, and a network device which uses the resources. The network device which uses the resources is referred to as “resources using device” hereinafter. The network device which holds the resources is referred to as “resources holding device” hereinafter. Examples of the resources holding device includes a DVD (Digital Versatile Disc) recorder and a hard disk drive (HDD) recorder.

When multiple users want to watch or listen the digital contents holded in the resources holding device from the resources using device, want to record the digital contents holded in the resources holding device onto the resources using device, or want to record the digital contents holded in the resources using device onto the resources holding device, some users may not be able to watch, listen or record the digital contents because of the fact that the resources (e.g. a recording medium which holds the digital contents or the resources holding device itself) related with the digital contents are already used.

Conventionally, in such a case, the resources using device is not notified that the resources in the resources holding device have become to be available. Accordingly, when the resources have become to be available, the conventional resources using device can neither notify the user that the resources have become to be available, nor automatically start reproducing or recording the digital contents.

### SUMMARY OF THE INVENTION

An object of the present invention is to provide a network system which allows a resources using device to notify a user that resources in the resources holding device have become to be available, or allows the resources using device to automatically start reproducing or recording the digital contents, when the user could not watch, listen or record the digital contents because of the fact that the resources are already used.

According to a first aspect of the present invention, we provide a network system including one network device (hereinafter referred to as “contents recording device”) which records digital contents, and other network devices (hereinafter referred to as “contents holding device”) which hold digital contents and are connected to the contents recording device via a network.

The contents recording device comprises: a contents list generating means for generating a contents list whose record has a flag (hereinafter referred to as “availability flag”) showing if the digital contents to be recorded by the contents recording device are available or not; a confirmation command sending means for sending to the each contents holding device a confirmation command to confirm whether the digital contents corresponding to each record stored in the contents list are available in the each contents holding device; a notification request command sending means for sending to the each contents holding device a notification request command to request to send to the contents recording device a notification (hereinafter referred to as “derestriction notification”) showing that the requested digital contents have become to be available when the contents recording device receives from the each contents holding device a response showing that the digital contents are unavailable; a flag setting means for setting the availability flag to a value which shows that the digital contents are unavailable when the response to the confirmation command from the each contents holding device shows that the digital contents are unavailable, and setting the availability flag to a value which shows that the digital contents are available when the response to the confirmation command from the each contents holding device shows that the digital contents are available; a receiving means for receiving from the each contents holding device the digital contents corresponding to the each record stored in the contents list via a network when the availability flag of the each record is set to the value which shows that the digital contents are available; and a recording means for recording the digital contents received by the receiving means.

The each contents holding device comprises: a response sending means for sending to the contents recording device the response to the confirmation command sent by the confirmation command sending means when the each contents holding device has received the confirmation command sent from the contents recording device; and a derestriction notification sending means for sending to the contents recording device the derestriction notification as soon as the unavailable digital contents corresponding to the derestriction notification have become to be available, after the each contents holding device has received the notification request command from the contents recording device.

According to this network system, even if the contents recording device (resources using device) could not record digital contents corresponding to a record stored in the contents list because of the fact that the resources corresponding to the digital contents are already used in the contents holding device (resources holding device) which holds the digital contents, the contents recording device can receive the derestriction notification from the contents holding device as soon as the resources become to be available. Thus, the contents recording device can recognize that the digital contents have become to be available. Accordingly, the contents recording device can automatically start recording the digital contents.

Preferably, an initial value of the availability flag of the each record stored in the contents list generated by the contents list generating means is the value which shows that the digital contents are available.

According to a second aspect of the present invention, we provide a network system including one network device (hereinafter referred to as “resources holding device”) which holds resources such as digital contents, and another network device (hereinafter referred to as “resources using device”) which uses the resources in the resources holding device and is connected to the resources holding device via a network.

The resources using device comprises: a confirmation command sending means for sending to the resources holding device a confirmation command to confirm whether the resources in the resources holding device are available; and a notification request command sending means for sending to the resources holding device a notification request command to request to send to the resources using device a notification (hereinafter referred to as “derestriction notification”) showing that the resources in the resources holding device have become to be available when the resources using device receives from the resources holding device a response showing that the resources in the resources holding device are unavailable.

The resources holding device comprises: a response sending means for sending to the resources using device the response to the confirmation command sent by the confirmation command sending means when the resources holding device has received the confirmation command sent from the resources using device; and a derestriction notification sending means for sending to the resources using device the derestriction notification as soon as the unavailable resources in the resources holding device corresponding to the derestriction notification have become to be available, after the resources holding device has received the notification request command from the resources using device.

According to this network system, even if the user could not watch or listen (the resources using device could not reproduce) the digital contents because of the fact that the resources in the resources holding device are already used, the resources using device can receive the derestriction notification from the resources holding device as soon as the resources become to be available. Thus, the resources using device can recognize that the required digital contents have become to be available. Accordingly, the resources using device can either notify the user that the required digital contents have become to be available or automatically start reproducing or recording the digital contents.

According to a third aspect of the present invention, we provide a network device (hereinafter referred to as “resources using device”) which uses the resources in another network device (hereinafter referred to as “resources holding device”) and is connected to the resources holding device via a network.

The resources using device comprises: a confirmation command sending means for sending to the resources holding device a confirmation command to confirm whether the resources in the resources holding device are available; and a notification request command sending means for sending to the resources holding device a notification request command to request to send to the resources using device a notification (hereinafter referred to as “derestriction notification”) showing that the resources in the resources holding device have become to be available when the resources using device receives from the resources holding device a response showing that the resources in the resources holding device are unavailable.

According to a fourth aspect of the present invention, we provide a network device (hereinafter referred to as “resources holding device”) which holds resources such as digital contents and is connected to another network device (hereinafter referred to as “resources using device”) which uses the resources in the resources holding device via a network.

The resources holding device comprises: a confirmation command receiving means for receiving from the resources using device a confirmation command to confirm whether the resources in the resources holding device are available; a response sending means for sending to the resources using device the response to the confirmation command received by the confirmation command receiving means; a notification request command receiving means for receiving from the resources using device a notification request command to request the resources holding device to send to the resources using device a notification (hereinafter referred to as “derestriction notification”) showing that the resources in the resources holding device have become to be available; and a derestriction notification sending means for sending to the resources using device the derestriction notification as soon as the unavailable resources in the resources holding device corresponding to the derestriction notification have become to be available, after the resources holding device has received the notification request command from the resources using device by the notification request command receiving means.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic configuration diagram of a network system according to a first embodiment of the present invention;

FIG. 2 is a flowchart showing a process performed by a contents reproducing device and a contents holding device in the network system.

FIG. 3 is a schematic configuration diagram of a network system according to a second embodiment of the present invention;

FIG. 4 is a flowchart showing a process performed by a contents holding device and a contents recording device in the network system.

FIG. 5 is a schematic configuration diagram of a network system according to a third embodiment of the present invention;

FIG. 6 is a schematic electrical block diagram of two sorts of network devices in the network system.

FIG. 7 is a flowchart showing a recording control process performed by the network device which records digital contents.

FIG. 8 is a tabular view showing an example of the records stored in a contents list in the network device.

FIG. 9 is a flowchart showing a process performed by the network device which records digital contents when the network device has received a derestriction notification from another network device which holds the digital contents.

FIG. 10 is a flowchart showing a process on the another network device corresponding to the recording processes shown in FIG. 7.

### DESCRIPTION OF THE PREFERRED EMBODIMENTS

Referring now to the accompanying drawings, the preferred embodiment of the present invention is described. The present invention relates to a network system including a network device (resources holding device) which holds resources such as digital contents, a recording medium, the device itself, or the like, and a network device (resources using device) which uses the resources. Examples of the resources holding device includes a DVD (Digital Versatile Disc) recorder and a hard disk drive (HDD) recorder. It is to be noted that the following description of preferred embodiment of the present invention has been presented for purposes of illustration and description, and is not intended to be exhaustive or to limit the present invention to the precise form disclosed.

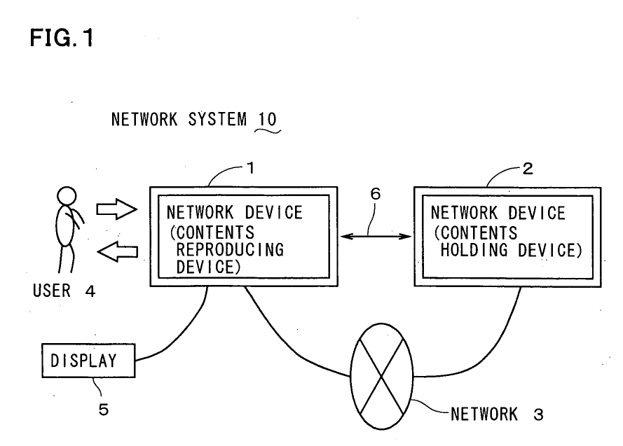

FIG. 1 shows a schematic diagram of a network system 10 according to a first embodiment of the present invention. In the first embodiment, a network device 1 (hereinafter referred to as “contents reproducing device”) which reproduces digital contents corresponds to the resources using device in claims 2, 3, and 4. A network device 2 (hereinafter referred to as “contents holding device”) which holds the digital contents corresponds to the resources holding device in claims 2, 3, and 4.

The network system 10 includes the contents reproducing device 1 and the contents holding device 2. The contents reproducing device 1 and the contents holding device 2 are connected to each other via a network 3. As shown by arrow 6 in FIG. 1, the contents reproducing device 1 and the contents holding device 2 can send and receive data such as digital contents to and from each other over the network 3. Chief examples of the network 3 includes networks between home electric appliances which meets standards such as Bluetooth, ZigBee, HomeRF (Home Radio Frequency), or the like. A display 5 is connected to the contents reproducing device 1.

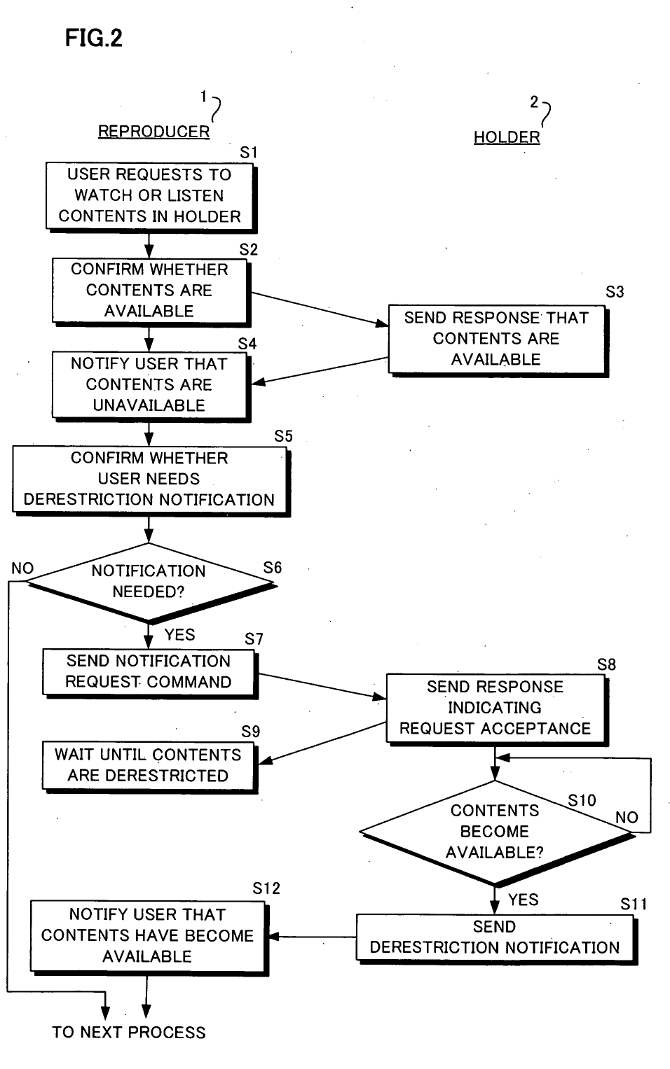

When a user 4 wants to watch or listen the digital contents holded in the contents holding device 2 (a holder in FIG. 2) from the contents reproducing device 1 (a reproducer in FIG. 2) which the user 4 can operate, the user 4 requests to watch or listen the digital contents holded in the contents holding device 2 from the contents reproducing device 1 (S 1) as shown in FIG. 2. Upon this request, the contents reproducing device 1 sends to the contents holding device 2 a confirmation command to confirm whether the requested digital contents are available (S2). When the contents holding device 2 has sent to the contents reproducing device 1 the response that the digital contents are unavailable (S3), the contents reproducing device 1 not only notifies the user 4 with a display 5 that the requested digital contents are unavailable (S4), but also displays on the display 5 a choice screen to confirm whether the user 4 needs notification (hereinafter referred to as “derestriction notification”) that the requested digital contents have become to be available (S5).

When the user 4 chooses to need the derestriction notification on the choice screen with input device (not shown) such as a remote controller (YES in S6), the contents reproducing device 1 sends to the contents holding device 2 a notification request command to request the contents holding device 2 to send the derestriction notification to the contents reproducing device 1 (S7). On receiving the notification request command, the contents holding device 2 sends to the contents reproducing device 1 a response indicating that the contents holding device 2 has accepted a request for the derestriction notification (S8).

When receiving the response from the contents holding device 2, the contents reproducing device 1 waits until the requested digital contents are derestricted (S9).

After then, when the digital contents holded in the contents holding device 2 have become to be available (have been derestricted) (YES in S10), the contents holding device 2 sends the derestriction notification to the contents reproducing device 1 (S11). Receiving the derestriction notification, the contents reproducing device 1 notifies the user 4 with the display 5 that the requested digital contents have become to be available (S12). For instance, if the contents reproducing device 1 is a PDA (personal digital assistant), the contents holding device 2 sends the derestriction notification in e-mail format to the contents reproducing device 1.

In the above-mentioned step S3, the contents holding device 2 sends to the contents reproducing device 1 the response that the digital contents are unavailable, when the resources (e.g. a recording medium which holds the digital contents or the contents holding device 2 itself) related with the digital contents are already used.

According to the network system 10 of the first embodiment, even if the user 4 could not watch or listen the digital contents because of the fact that the resources related with the digital contents are already used, the contents reproducing device 1 can receive the derestriction notification from the contents holding device 2 as soon as the resources become to be available. Thus, the contents reproducing device 1 can recognize that the required digital contents have become to be available. Accordingly, the contents reproducing device 1 can notify the user 4 that the required digital contents have become to be available.

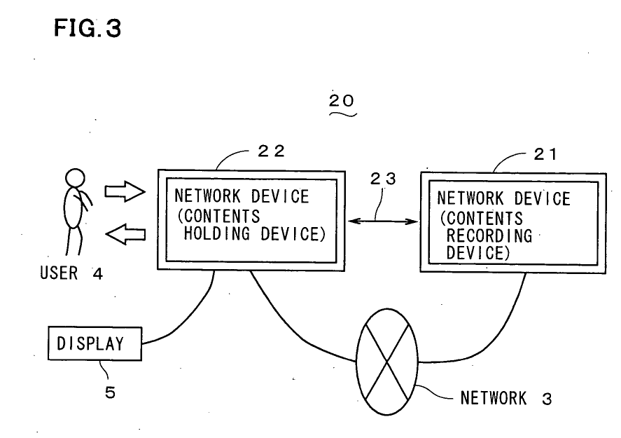

FIG. 3 shows a schematic diagram of a network system 20 according to a second embodiment of the present invention. In the second embodiment, a network device 22 (hereinafter referred to as “contents holding device”) which holds digital contents corresponds to the resources using device in claims 2, 3, and 4. A network device 21 (hereinafter referred to as “contents recording device”) which records the digital contents corresponds to the resources holding device in claims 2, 3, and 4.

The network system 20 includes the contents holding device 22 and the contents recording device 21. The contents holding device 22 and the contents recording device 21 are connected to each other via a network 3. As shown by arrow 23 in FIG. 3, the contents holding device 22 and the contents recording device 21 can send and receive data such as digital contents to and from each other over the network 3.

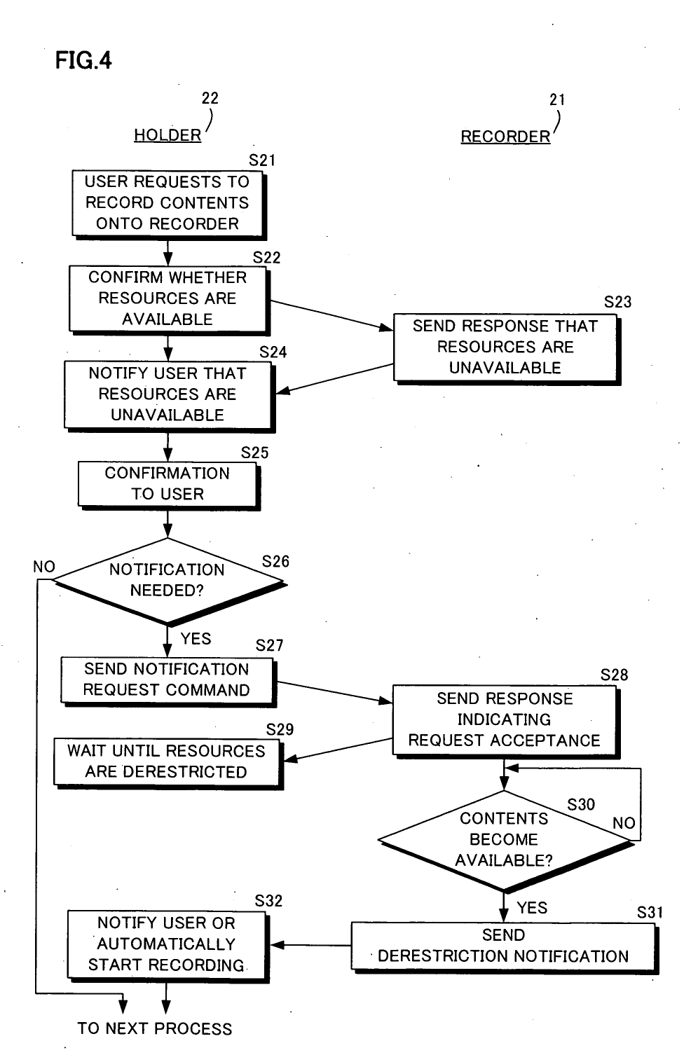

When a user 4 wants to record onto the contents recording device 21 (a recorder in FIG. 4) the digital contents holded in the contents holding device 22 (a holder in FIG. 4) which the user 4 can operate, the user 4 operates the contents holding device 22 in order to request to record the digital contents onto the contents recording device 21 (S21) as shown in FIG. 4. Upon this request, the contents holding device 22 sends to the contents recording device 21 a confirmation command to confirm whether resources (e.g. a recording medium or the contents recording device 21 itself) related with recording function in the contents recording device 21 are available (S22). When the contents recording device 21 has sent to the contents holding device 22 the response that the resources are unavailable (S23), the contents holding device 22 not only notifies the user 4 with a display 5 that the resources in the contents recording device 21 are unavailable (S24), but also displays on the display 5 a first choice screen to confirm whether the user 4 needs notification (hereinafter referred to as “derestriction notification”) that the resources have become to be available, or a second choice screen to confirm whether the contents holding device 22 automatically record the digital contents onto the contents recording device 21 as soon as the resources become to be available (S25).

In the above-mentioned step S25, when the user 4 chooses to need the derestriction notification on the first choice screen with input device (not shown) such as a remote controller (YES in S26), the contents holding device 22 sends to the contents recording device 21 a notification request command to request the contents recording device 21 to send the derestriction notification to the contents holding device 22 (S27). On receiving the notification request command, the contents recording device 21 sends to the contents holding device 22 a response indicating that the contents recording device 2.1 has accepted a request for the derestriction notification (S28).

When receiving the response from the contents recording device 21, the contents holding device 22 waits until the resources in the contents recording device 21 are derestricted (S29).

After then, when the resources in the contents recording device 21 have become to be available (have been derestricted) (YES in S30), the contents recording device 21 sends the derestriction notification to the contents holding device 22 (S31). Receiving the derestriction notification, the contents holding device 22 notifies the user 4 with the display 5 that the resources in the contents recording device 21 have become to be available (S32).

In the above-mentioned step S25, when the user 4 chooses to automatically record the digital contents onto the contents recording device 21 on the second choice screen, the contents holding device 22 automatically starts recording the digital contents onto the contents recording device 21 on receiving the derestriction notification from the contents recording device 21 (S32).

In the above-mentioned step S23, the contents recording device 21 sends to the contents holding device 22 the response that the resources are unavailable, when the resources (e.g. a recording medium or the contents recording device 21 itself) related with the digital contents in the contents recording device 21 are already used.

According to the network system 20 of the second embodiment, even if the contents holding device 22 could not record the digital contents onto the contents recording device 21 because of the fact that the resources related with recording function in the contents recording device 21 are already used, the contents holding device 22 can receive the derestriction notification from the contents recording device 21 as soon as the resources become to be available. Thus, the contents holding device 22 can recognize that the digital contents have become to be able to be recorded onto the contents recording device 21. Accordingly, the contents holding device 22 can either notify the user 4 that the digital contents have become to be able to be recorded onto the contents recording device 21 (the resources in the contents recording device 21 have become to be available ) or automatically record the digital contents onto the contents recording device 21.

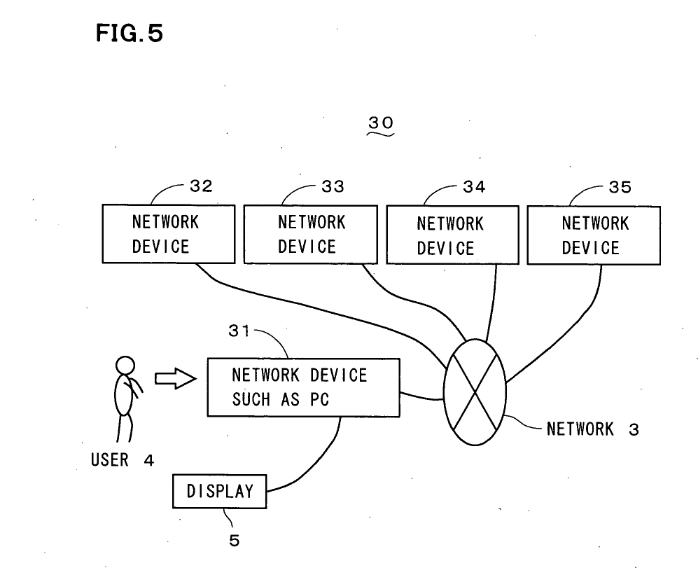

FIG. 5 shows a schematic diagram of a network system 30 according to a third embodiment of the present invention. In the third embodiment, a network device 31 such as a personal computer which records digital contents corresponds to the contents recording device in claim 1. A network device 32, 33, 34, and 35 which hold the digital contents corresponds to the contents holding device in claim 1.

The network system 30 includes the network device 31, 32, 33, 34, and 35. The network device 31, 32, 33, 34, and 35 are connected to one another via a network 3. The network device 31 which records digital contents can send and receive data such as the digital contents to and from the network device 32, 33, 34, and 35 which hold the digital contents.

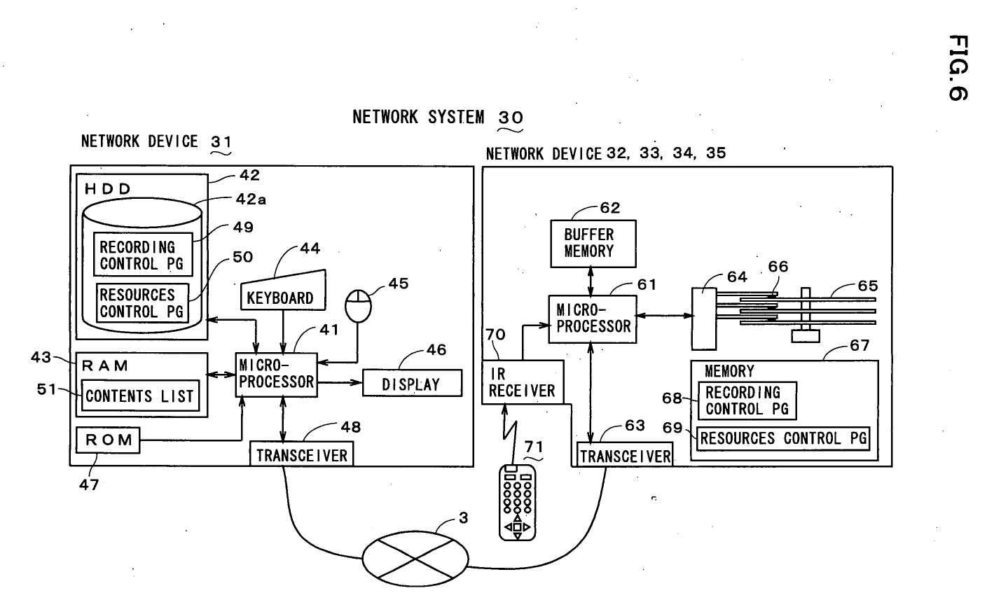

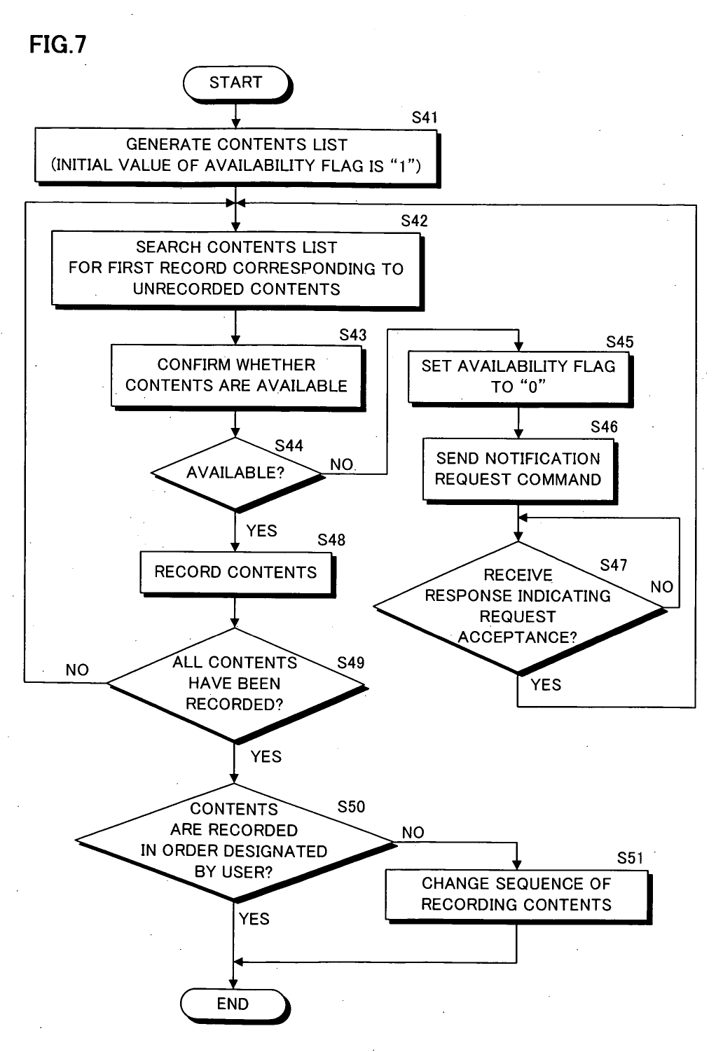

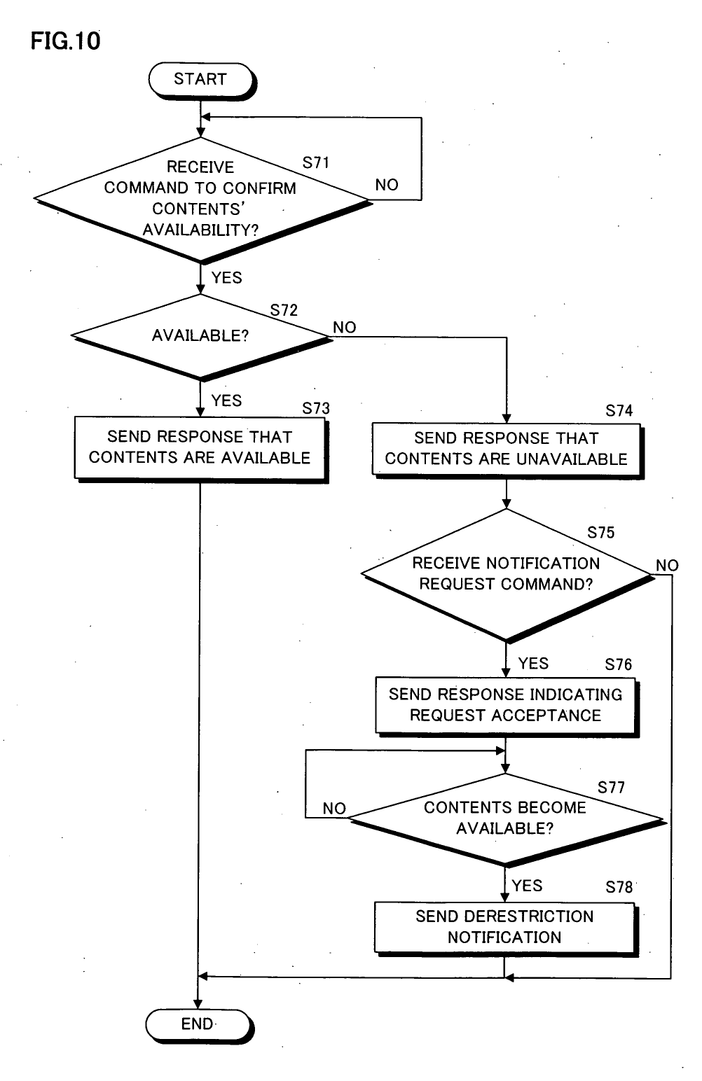

FIG. 6 shows a schematic electrical block diagram of the network device 31 and the network device 32, 33, 34, and 35 for the case where the network device 31 is a personal computer and where the network device 32, 33, 34, and 35 are hard disk recorders. In FIG. 6, the network device 32, 33, 34, and 35 are expressed in one hard disk recorder because they have the same configuration. The network device 31 comprises a microprocessor 41 which controls the entire network device 31. The network device 31 comprises a hard disk drive 42 having a hard disk 42a built-in. The hard disk 42a stores various data including programs such as a recording control program (recording control PG) 49 and a resources control program (resources control PG) 50. The recording control PG 49 is a program for performing recording control process shown in FIG. 7 and flag setting process shown in FIG. 9. The resources control PG 50 is a program for performing derestriction notification sending process shown in FIG. 10 in case where the network device 31 is the contents holding device in claim 1. The microprocessor 41 and recording control PG 49 correspond to the contents list generating means and the flag setting means in claim 1.

The network device 31 further comprises a random access memory (RAM) 43 where various programs including the recording control PG 49 are loaded, a keyboard 44 and a mouse 45 for inputting various instructions, a display unit 46 for displaying various messages or the like, a read only memory (ROM) 47 for storing various control programs, and a transceiver unit 48 for sending and receiving data such as the digital contents to and from the network device 32, 33, 34, or 35 over the network 3. The microprocessor 41, recording control PG 49 and the transceiver unit 48 correspond to the confirmation command sending means, the notification request command sending means, and the receiving means in claim 1.

The network device 32, 33, 34, or 35 comprises a microprocessor 61 which controls the entire network device 32, 33, 34, or 35, a memory 67 for storing control programs for the microprocessor 61 therein, and a transceiver unit 63 for sending and receiving data such as the digital contents and control commands to and from the network device 31 over the network 3. The control programs stored in the memory 67 include a recording control program (recording control PG) 68 and a resources control program (resources control PG) 69. The recording control PG 68 is a program for performing the recording control process shown in FIG. 7 and the flag setting process shown in FIG. 9 in case where the network device 31 is the contents recording device in claim 1. The resources control PG 69 is a program for performing derestriction notification sending process shown in FIG. 10. The microprocessor 61, the resources control PG 69, and the transceiver unit 63 correspond to the response sending means and the derestriction notification sending means in claim 1.

The network device 32, 33, 34, or 35 further comprises: multiple hard disks 65 which are recording media; multiple magnetic heads 66 for writing and reading data to and from the hard disks 65; a head drive unit 64 for driving the magnetic heads 66; a buffer memory 62 for temporarily storing the data to be recorded or the read data; and an infrared signal receiver (IR receiver) 70 for receiving a command signal in an infrared signal format sent from a remote control 71.

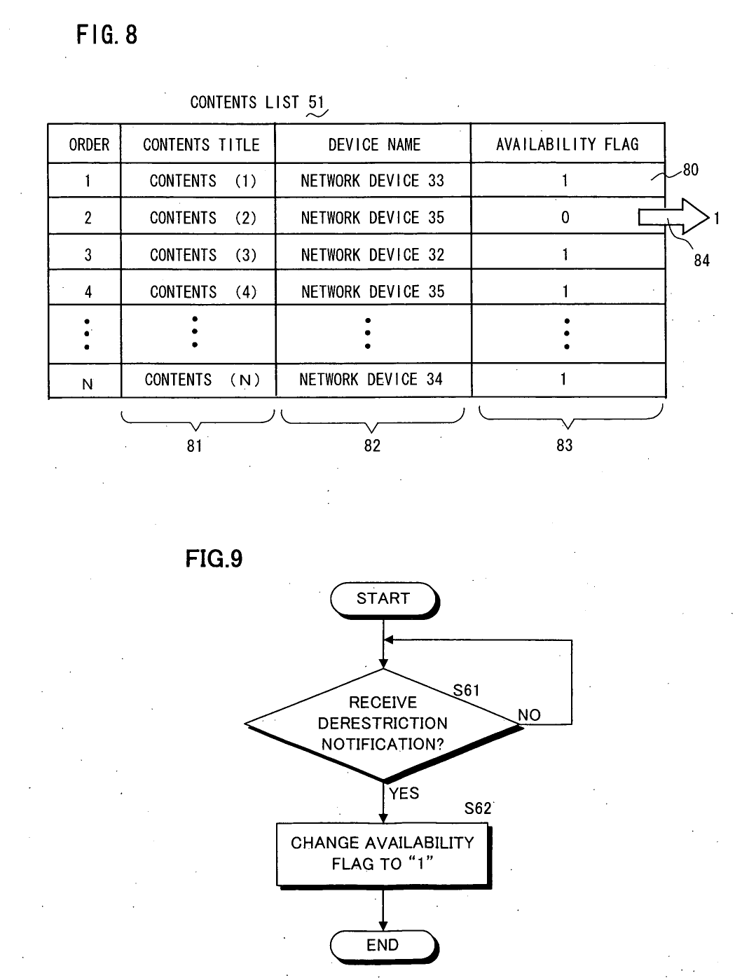

When a user 4 wants to record onto the hard disk drive 42 in the network device 31 plural digital contents holded in the plural network device 32, 33, 34, and 35, the user 4 designates the plural digital contents to be recorded among digital contents holded in the plural network device 32, 33, 34, and 35 with a mouse 45 or a keyboard 44. Upon the designation of the plural digital contents, the microprocessor 41 of the network device 31 generates a contents list 51 shown in FIG. 8 based on content of the designation (S41 in FIG. 7).

As shown in FIG. 8, each record 80 included in the contents list 51 has a contents title 81 of digital contents which is recorded on the the network device 31, a device name 82, and an availability flag 83; The device name 82 is a name of the network device 32, 33, 34, or 35 which holds the digital contents corresponding to the contents title 81. The availability flag 83 is a flag showing if the digital contents are available or not. Note that immediately after the contents list 51 has been generated, the availability flags 83 of all records 80 included in the contents list 51 are set to “1” which shows that the digital contents are available. In other words, an initial value of the availability flag 83 of each record 80 is “1”.

After performing the process shown in the step S41, the microprocessor 41 searches the contents list 51 for the first record corresponding to one of the digital contents, which the network device 31 has not finished recording yet in the order designated by the user (in the order stored in the contents list 51) (S42). Subsequently, the microprocessor 41 of the network device 31 sends to the network device 32, 33, 34, or 35 holding the digital contents a confirmation command to confirm whether the digital contents corresponding to the first found record 80 are available (S43).

When the network device 32, 33, 34, or 35 has sent to the network device 31 the response that the digital contents are unavailable (NO in S44), the microprocessor 41 of the network device 31 sets the availability flag 83 (in the contents list 51) corresponding to the unavailable digital contents to “0” which shows that the digital contents are unavailable (S45). Subsequently, the microprocessor 41 of the network device 31 sends to the network device 32, 33, 34, or 35 a notification request command to request the network device 32, 33, 34,.or 35 to send the derestriction notification to the network device 31 (S46) as soon as the digital contents have become to be available. When receiving a response indicating that the network device 32, 33, 34, or 35 has accepted the notification request command (YES in S47), the microprocessor 41 of the network device 31 searches the contents list 51 for the first record whose availability flag 83 is set to “1”, and which corresponds to the digital contents that the network device 31 has not finished recording yet (S42) in the order stored in the contents list 51. The microprocessor 41 of the network device 31 performs the processes shown in the step S43 and S44 on the digital contents corresponding to the first found record.

When the microprocessor 41 of the network device 31 receives from the network device 32, 33, 34, or 35 the response that the digital contents are available (YES in S44), the microprocessor 41 of the network device 31 requests the network device 32, 33, 34, or 35 which sent the response to send the digital contents to the network device 31. Subsequently, the microprocessor 41 of the network device 31 receives the digital contents from the network device 32, 33, 34, or 35 over the network 3 so as to record this digital contents onto the hard disk 42a (S48).

After having finished recording all the digital contents whose titles are set in the contents list 51 (YES in S49), the microprocessor. 41 of the network device 31 determines whether the digital contents on the hard disk 42a are recorded in the order designated by the user. As a result, when the microprocessor 41 of the network device 31 determines that the digital contents on the hard disk 42a are not recorded in the order designated by the user (NO in S50), the microprocessor 41 of the network device 31 automatically changes a sequence of recording the digital contents on the hard disk 42a so that the digital contents on the hard disk 42a is recorded in the order designated by the user (S51).

As shown in FIG. 9, when receiving from the network device 32, 33, 34, or 35 the derestriction notification regarding digital contents which was unavailable (YES in S61), the microprocessor 41 of the network device 31 changes the availability flag 83 regarding the digital contents from “0” (unavailable) to “1” (available) (S62) as shown by an arrow 84 in FIG. 8. Thus, the microprocessor 41 determines that the digital contents corresponding to the record 80 whose availability flag 83 has been changed to “1” become to be available in the step S44. Accordingly, the microprocessor 41 of the network device 31 can automatically start recording the digital contents. In other words, the microprocessor 41 of the network device 31 receives from the network device 32, 33, 34, or 35 the digital contents corresponding to the record 80 whose availability flag 83 has been changed to “1” so as to record this digital contents onto the hard disk 42a (S48).

Next, referring to FIG. 10, the processes on the network device 32, 33, 34, or 35 corresponding to the recording processes on the network device 31 shown in FIG. 7 is described. On receiving from the network device 31 a confirmation command to confirm whether the digital contents holded in the network device 32, 33, 34, or 35 itself are available (YES in S71), the microprocessor 61 of the network device 32, 33, 34, or 35 confirms whether the digital contents are available (S72). When the digital contents are available (YES in S72), the microprocessor 61 of the network device 32, 33, 34, or 35 sends to the network device 31 a response indicating that the digital contents are available (S73).

On the other hand, when the digital contents are unavailable (NO in S72), the microprocessor 61 of the network device 32, 33, 34, or 35 sends to the network device 31 a response indicating that the digital contents are unavailable (S74). Subsequently, on receiving the notification request command shown in the step S46 from the network device 31 (YES in S75), the microprocessor 61 of the network device 32, 33, 34, or 35 sends to the network device 31 a response indicating that the network device 32, 33, 34, or 35 has accepted a request for the derestriction notification (S76). After then, when the digital contents corresponding to the request for the derestriction notification have become to be available (have been derestricted) (YES in S77), the microprocessor 61 of the network device 32, 33, 34, or 35 sends to the network device 31 the derestriction notification corresponding to the derestricted digital contents (S78).

According to the network system 30 of the third embodiment, even if the network device 31 could not record digital contents corresponding to a record 80 stored in the contents list 51 because of the fact that the resources (e.g. the digital contents, a recording medium (the hard disk 65) which holds the digital contents or the network device itself) corresponding to the digital contents are already used in the network device 32, 33, 34, or 35, the network device 31 can receive the derestriction notification from the network device 32, 33, 34, or 35 as soon as the resources become to be available. Thus, the network device 31 can recognize that the digital contents have become to be available. Accordingly, the network device 31 can automatically start recording the digital contents.

It is to be noted that the present invention is not limited to the above-described embodiments, and various modifications are possible. For example, the third embodiment shows the case where the network device 32, 33, 34, or 35 is a hard disk recorder. However, the network device 32, 33, 34, or 35 can be a DVD (Digital Versatile Disc) recorder or the like. Furthermore, the third embodiment shows the case where the network device 31 is a personal computer. However, the network device 31 can be a a hard disk recorder or a DVD recorder.

Furthermore, the first embodiment shows the case where the contents reproducing device 1 notifies the user 4 that the required digital contents have become to be available when the contents reproducing device 1 has received the derestriction notification from the contents holding device 2. However, the contents reproducing device 1 may automatically start reproducing the required digital contents when the contents reproducing device 1 has received the derestriction notification from the contents holding device 2.

Furthermore, the network 3 is not limited to a network which meets a wireless communication standard such as Bluetooth, ZigBee, HomeRF (Home Radio Frequency), or the like, but can be a network which meets a wire communication standard such as an IEEE 1394.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2005-058104 filed Mar. 2, 2005, the contents of which are hereby incorporated by reference.

What is claimed is:

1. A network system including one network device (hereinafter referred to as “contents recording device”) which records digital contents, and other network devices (hereinafter referred to as “contents holding device”) which hold digital contents and are connected to the contents recording device via a network,
wherein the contents recording device comprises:
a contents list generating means for generating a contents list whose record has a flag (hereinafter referred to as “availability flag”) showing if the digital contents to be recorded by the contents recording device are available or not;
a confirmation command sending means for sending to the each contents holding device a confirmation command to confirm whether the digital contents corresponding to each record stored in the contents list are available in the each contents holding device;
a notification request command sending means for sending to the each contents holding device a notification request command to request to send to the contents recording device a notification (hereinafter referred to as “derestriction notification”) showing that the requested digital contents have become to be available when the contents recording device receives from the each contents holding device a response showing that the digital contents are unavailable;
a flag setting means for setting the availability flag to a value which shows that the digital contents are unavailable when the response to the confirmation command from the each contents holding device shows that the digital contents are unavailable, and setting the availability flag to a value which shows that the digital contents are available when the response to the confirmation command from the each contents holding device shows that the digital contents are available;
a receiving means for receiving from the each contents holding device the digital contents corresponding to the each record stored in the contents list via a network when the availability flag of the each record is set to the value which shows that the digital contents are available; and
a recording means for recording the digital contents received by the receiving means, and
wherein the each contents holding device comprises:
a response sending means for sending to the contents recording device the response to the confirmation command sent by the confirmation command sending means when the each contents holding device has received the confirmation command sent from the contents recording device; and
a derestriction notification sending means for sending to the contents recording device the derestriction notification as soon as the unavailable digital contents corresponding to the derestriction notification have become to be available, after the each contents holding device has received the notification request command from the contents recording device.

2. The network system according to claim 1,
wherein an initial value of the availability flag of the each record stored in the contents list generated by the contents list generating means is the value which shows that the digital contents are available.

3. A network system including one network device (hereinafter referred to as “resources holding device”) which holds resources such as digital contents, and another network device (hereinafter referred to as “resources using device”) which uses the resources in the resources holding device and is connected to the resources holding device via a network,
wherein the resources using device comprises:
a confirmation command sending means for sending to the resources holding device a confirmation command to confirm whether the resources in the resources holding device are available; and
a notification request command sending means for sending to the resources holding device a notification request command to request to send to the resources using device a notification (hereinafter referred to as “derestriction notification”) showing that the resources in the resources holding device have become to be available when the resources using device receives from the resources holding device a response showing that the resources in the resources holding device are unavailable, and
wherein the resources holding device comprises:
a response sending means for sending to the resources using device the response to the confirmation command sent by the confirmation command sending means when the resources holding device has received the confirmation command sent from the resources using device; and
a derestriction notification sending means for sending to the resources using device the derestriction notification as soon as the unavailable resources in the resources holding device corresponding to the derestriction notification have become to be available, after the resources holding device has received the notification request command from the resources using device.

4. A network device (hereinafter referred to as “resources using device”) which uses the resources in another network device (hereinafter referred to as “resources holding device”) and is connected to the resources holding device via a network, the resources using device comprising:
a confirmation command sending means for sending to the resources holding device a confirmation command to confirm whether the resources in the resources holding device are available; and
a notification request command sending means for sending to the resources holding device a notification request command to request to send to the resources using device a notification (hereinafter referred to as “derestriction notification”) showing that the resources in the resources holding device have become to be available when the resources using device receives from the resources holding device a response showing that the resources in the resources holding device are unavailable.

5. A network device (hereinafter referred to as “resources holding device”) which holds resources such as digital contents and is connected to another network device (hereinafter referred to as “resources using device”) which uses the resources in the resources holding device via a network, the resources holding device comprising:
a confirmation command receiving means for receiving from the resources using device a confirmation command to confirm whether the resources in the resources holding device are available;
a response sending means for sending to the resources using device the response to the confirmation command received by the confirmation command receiving means;
a notification request command receiving means for receiving from the resources using device a notification request command to request the resources holding device to send to the resources using device a notification (hereinafter referred to as “derestriction notification”) showing that the resources in the resources holding device have become to be available; and
a derestriction notification sending means for sending to the resources using device the derestriction notification as soon as the unavailable resources in the resources holding device corresponding to the derestriction notification have become to be available, after the resources holding device has received the notification request command from the resources using device by the notification request command receiving means.
